(19) United States
(12) Patent Application Publication
(10) Pub. No.: US 2012/0034386 A1
(43) Pub. Date: Feb. 9, 2012

(54) APPARATUS AND METHOD FOR COATING

(75) Inventors: Yoong Oh, Suwon-si (KR); Jong-Seok Bae, Yongin-si (KR)

(73) Assignee: SAMSUNG ELECTRO-MECHANICS CO., LTD., Suwon-si (KR)

(21) Appl. No.: 13/196,777

(22) Filed: Aug. 2, 2011

(30) Foreign Application Priority Data
Aug. 9, 2010 (KR) 10-2010-0076591

(51) Int. Cl. B05D 3/12; B05C 11/04

(52) U.S. Cl. 427/369; 118/100; 118/103

(57) ABSTRACT

An apparatus and a method for coating are disclosed. The coating apparatus of the present invention, which include: a transporting part configured to transport a substrate; a coating part configured to coat a coating material on the substrate; and a squeegee installed to remove an excessive coating material after the substrate passes through the coating part and being moveable along a transporting path of the substrate, can carry out the coating operation and the squeegeeing operation together, thereby reducing the lead time of the coating operation of the substrate and increasing the productivity. By integrating the conventional coating device and squeegeeing device, the space required for installation can be saved, and the quality of coating can be improved because conditions for coating can be adjusted.

### CROSS-REFERENCE TO RELATED APPLICATIONS

This application claims the benefit of Korean Patent Application No. 10-2010-0076591, filed with the Korean Intellectual Property Office on Aug. 9, 2010, the disclosure of which is incorporated herein by reference in its entirety.

### BACKGROUND

1. Technical Field

The present invention relates to an apparatus and a method for coating.

2. Background Art

A coating process for a substrate is generally divided into a coating operation, in which a coating material is coated, and a squeegeeing operation, in which excessive coating material is removed.

However, since the coating operation and the squeegeeing operation are carried out separately due to limitations of devices, an elongated period of time is spent to move and arrange the substrate between the devices, causing the lead time to increase and the productivity to decrease.

### SUMMARY

The present invention provides an apparatus and a method for coating that can perform the coating operation and the squeegeeing operation at the same time.

An aspect of the present invention features a coating apparatus, which includes: a transporting part configured to transport a substrate; a coating part configured to coat a coating material on the substrate; and a squeegee installed to remove an excessive coating material after the substrate passes through the coating part and being moveable along a transporting path of the substrate.

The squeegee is capable of adjusting a moving speed so that a relative speed to the substrate can be adjusted.

The squeegee is capable of adjusting a pressure of squeegeeing against the substrate.

The squeegee can be arranged in a pair facing each other, and a gap between the pair of squeegees is adjustable.

The coating part can include a pair of coating rollers that are arranged to face each other, and the squeegee can be arranged in a pair arranged to correspond to the pair of coating rollers.

Another aspect of the present invention features a method of coating, which includes: transporting a substrate; coating a coating material on the substrate being transported; and removing an excessive coating material with a squeegee while adjusting a moving speed of the squeegee against the substrate being transported.

The method can also include adjusting a pressure of squeegeeing the substrate.

### BRIEF DESCRIPTION OF THE DRAWINGS

FIG. 1 shows a coating apparatus in accordance with an embodiment of the present invention.

FIG. 2 is a flow diagram illustrating a method for coating in accordance with an embodiment of the present invention.

FIGS. 3 to 5 illustrate a method for coating in accordance with an embodiment of the present invention.

### DETAILED DESCRIPTION

Hereinafter, certain embodiment of the present invention will be described with reference to the accompanying drawings.

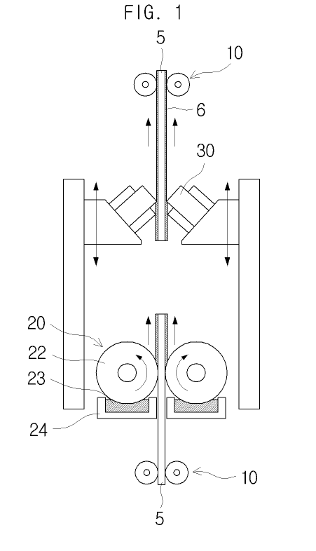

FIG. 1 shows a coating apparatus in accordance with an embodiment of the present invention.

The coating apparatus in accordance with an embodiment of the present invention includes a transporting part 10, a coating part 20 and a squeegee 30.

The transporting part 10 is a part that transports a substrate 5 on which a coating operation is to be performed, and includes a variety of known transporting devices.

As illustrated in FIG. 1, the transporting part 10 of the present embodiment includes transporting rollers that puts the substrate 5 into the coating apparatus and takes the coated substrate 5 out.

The coating part 20 is a part that coats a coating material 23 on the substrate 5. By making the coating operation possible for the substrate 5 that is being transported, the coating part 20 of the present embodiment can consecutively coat a plural number of substrates 5 that are being transported.

As illustrated in FIG. 1, the coating part 20 of the present embodiment includes a pair of coating rollers 22 that are arranged to face each other on a path through which the substrate 5 passes. The pair of coating rollers 22 are partially dipped in a tank filled with the coating material 23, and each of the pair of the coating rollers 22 is installed to rotate clockwise or counter-clockwise according to the direction in which the substrate 5 is transported. Accordingly, the coating material 23 is coated on either side of the substrate 5 as the substrate 5 passes between the pair of coating rollers 22. In the present embodiment, solder resist is used as the coating material 23 in order to form a solder resist layer on either side of the substrate 5. In addition, a pair of squeegees 30 are arranged to face each other and to correspond to the pair of coating rollers 22 so that unnecessary portions of the coating material 23 can be removed.

The coating part 20 is not restricted to what is described in the present embodiment, and can be embodied in various forms, such as a spray.

The squeegee 30 is a part that is installed on a transporting path of the substrate 5 to remove an excessive coating material 23 after the substrate 5 passes through the coating part 20. The squeegee 30 can remove an unnecessary coating material 23 by being closely contacted with the substrate 5 or spaced by a certain distance from the substrate 5. In the present embodiment, it is possible to move the squeegee 30 along the transporting path of the substrate 5.

The quality of coating operation and squeegeeing operation is closely related to the transporting speed of the substrate 5. Accordingly, in case the transporting speed of the substrate 5 is optimized for any one of the two operations, the quality of the other operation is inadvertently deteriorated. This is why it is difficult to integrate the devices used for the coating operation and the squeegeeing operation.

In the present embodiment, the above problem can be solved by allowing the squeegee 30 to move along the transporting path of the substrate 5.

As illustrated in FIG. 1, the transporting speed of the substrate 5 can be configured to be appropriate for the coating operation, and a relative speed of the squeegee 30 to the substrate 5 that is appropriate for the squeegeeing operation can be optimized by adjusting a moving speed of the squeegee 30.

Accordingly, since the coating operation and the squeegeeing operation are carried out together, the lead time of the coating operation of the substrate 5 can be reduced, thereby increasing the productivity. Moreover, by integrating the conventional coating device and squeegeeing device, the space required for installation can be saved.

The squeegee 30 of the present embodiment can adjust the pressure of squeegeeing the substrate 5. Specifically, in the present embodiment, the squeegeeing pressure can be adjusted by adjusting the distance of the squeegee 30 from the substrate 5.

As illustrated in FIG. 1, in the present embodiment, a pair of squeegees 30 are arranged to face each other on the transporting path of the substrate 5. Here, the squeegeeing pressure can be readily adjusted by allowing a gap between the pair of squeegees 30 to be adjusted.

Therefore, the present embodiment can adjust squeegeeing conditions such as squeegeeing speed and pressure, etc., and thus the quality of coating can be improved by forming a coating layer 6 that has good flatness but has no lump. Moreover, in case the thickness of the substrate 5 is to be changed (i.e., the product is changed), the squeegeeing pressure can be maintained constantly according to the change in thickness.

Hereinafter, a method of coating in accordance with an embodiment of the present invention will be described in detail.

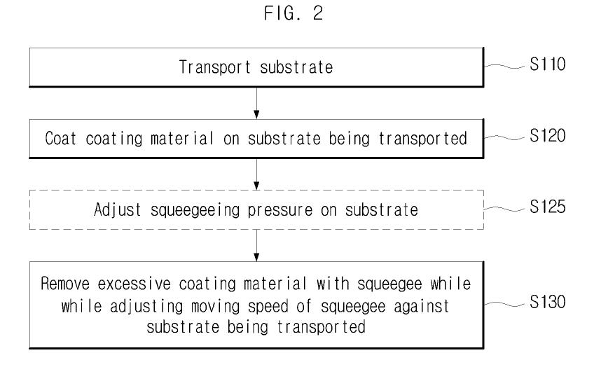

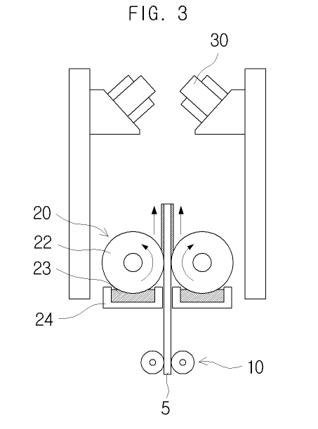

FIG. 2 is a flow diagram illustrating a method for coating in accordance with an embodiment of the present invention, and FIGS. 3 to 5 illustrate the method for coating in accordance with an embodiment of the present invention.

The method for coating in accordance with an embodiment of the present invention includes transporting a substrate (S110), coating a coating material (S120) and squeegeeing (S130).

In the step of transporting a substrate (S110), a substrate 5 is transported to a coating part 20 and a squeegee 30 by use of a known transporting apparatus.

As illustrated in FIG. 3, in the present embodiment, the substrate 5 is transported by use of a transporting roller.

In the step of coating a coating material (S120), a coating material 23 is coated on the substrate 5 that is being transported. In the present embodiment, a coating operation can be consecutively carried out on a plural number of substrates 5 that are being transported, thereby increasing the productivity.

As illustrated in FIG. 3, in the preset embodiment, a pair of coating rollers 22 that are arranged to face each other on a path through which the substrate 5 passes are installed. The pair of coating rollers 22 are partially dipped in a tank filled with the coating material 23, and each of the pair of the coating rollers 22 is installed to rotate clockwise or counter-clockwise according to the direction in which the substrate 5 is transported. Accordingly, the coating material 23 can be coated on either side of the substrate 5 as the substrate 5 passes between the pair of coating rollers 22. In the present embodiment, solder resist is used as the coating material 23 in order to form a solder resist layer on either side of the substrate 5.

The step of coating a coating material (S120) is not restricted to what is described in the present embodiment and can be embodied in various forms, such as spraying.

In the step of squeegeeing (S130), an excessive coating material 23 is removed by the squeegee 30 while adjusting a moving speed of the squeegee 30 against the substrate 5 that is being transported. Accordingly, the transporting speed of the substrate 5 can be configured to be appropriate for the coating operation, and a relative speed of the squeegee 30 to the substrate 5 that is appropriate for the squeegeeing operation can be optimized by adjusting the moving speed of the squeegee 30. Therefore, since the coating operation and the squeegeeing operation are carried out together, the lead time of the coating operation of the substrate 5 can be reduced, thereby increasing the productivity.

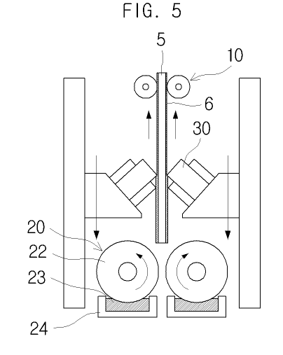

As illustrated in FIG. 5, in the present embodiment, a pair of squeegees 30 are arranged to face each other on the transporting path of the substrate 5. Here, by having the pair of squeegees 30 in an opposite direction from the transporting direction of the substrate 5, the speed of squeegeeing can be increased.

Moreover, in the present embodiment, the pressure of squeegeeing the substrate 5 can be adjusted (S125).

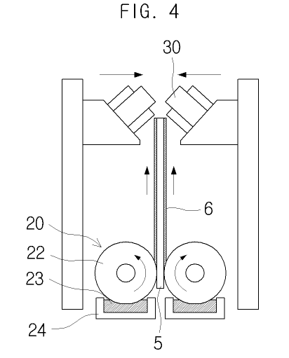

As illustrated in FIG. 4, the squeegeeing pressure can be readily adjusted by allowing a gap between the pair of squeegees 30 to be adjusted.

Although the present embodiment has described that the squeegeeing is optimized when the speed of squeegeeing is higher than the transporting speed of the substrate 5, it is also possible that the squeegee 30 is moved in the same direction as the transporting direction of the substrate 5 in case a squeegeeing speed that is lower than the transporting speed of the substrate 5 is needed. Moreover, although the coating part 20 and the squeegee 30 are integrated in the present embodiment, it is also possible that the coating part 20 and the squeegee 30 are separately installed as needed.

Although some embodiment of the present invention has been described above, it shall be appreciated that there can be a variety of permutations and modifications of the present invention by those who are ordinarily skilled in the art to which the present invention pertains without departing from the technical ideas and scope of the present invention, which shall be defined by the appended claims.

It shall be also appreciated that many embodiments other than the embodiment described above are present in the claims of the present invention.

What is claimed is:

1. A coating apparatus comprising:
a transporting part configured to transport a substrate;
a coating part configured to coat a coating material on the substrate; and
a squeegee installed to remove an excessive coating material after the substrate passes through the coating part and being moveable along a transporting path of the substrate.

2. The coating apparatus of claim 1, wherein the squeegee is capable of adjusting a moving speed so that a relative speed to the substrate can be adjusted.

3. The coating apparatus of claim 1, wherein the squeegee is capable of adjusting a pressure of squeegeeing against the substrate.

4. The coating apparatus of claim 3, wherein the squeegee is arranged in a pair facing each other, a gap between the pair of squeegees being adjustable.

5. The coating apparatus of claim 1, wherein:
the coating part comprises a pair of coating rollers that are arranged to face each other; and
the squeegee is arranged in a pair arranged to correspond to the pair of coating rollers.

6. A method of coating, comprising:
transporting a substrate;
coating a coating material on the substrate being transported; and
removing an excessive coating material with a squeegee while adjusting a moving speed of the squeegee against the substrate being transported.

7. The method of claim 6, further comprising adjusting a pressure of squeegeeing the substrate.
